(19) United States
(12) Patent Application Publication
(10) Pub. No.: US 2018/0106046 A1
(43) Pub. Date: Apr. 19, 2018

(54) MODULAR MULTIFUNCTION SHADING DEVICE, PARTICULARLY FOR A PERGOLA

(71) Applicant: Jean-Louis Castel, Poitiers (FR)

(72) Inventor: Jean-Louis Castel, Poitiers (FR)

(21) Appl. No.: 15/568,845

(22) PCT Filed: Apr. 21, 2016
(86) PCT No.: PCT/FR2016/050933

§ 371 Date: Oct. 24, 2017

(30) Foreign Application Priority Data
Apr. 24, 2015 (FR) 1553713

(51) Int. Cl. E04F 10/06; E04F 10/10

(52) U.S. Cl. CPC E04F 10/0607; E06B 9/40; E04F 10/0648; E04F 10/10

(57) ABSTRACT

A multifunction shading device, such as, for creating a pergola, including a structure that provides support for the device, modules equipped with a blind and a mechanism configured to control a length of the blind distributed along one axis of the structure.

This invention relates to a modular multifunction shading device, particularly for a pergola, to control the quality, extent and nature of the shading.

Pergola devices are known that allow the shading to be adjusted depending on requirements and depending on meteorological conditions.

Patent application FR 2 676 079 describes an arrangement with swiveling blades that ensure total shading when they are in a horizontal position, an interruption of the sunrays when the blades are perpendicular to the sunrays and offer minimal shading when the blades are parallel to the sunrays. According to an enhancement, the blades also comprise edge profiles that cooperate with each other to ensure a seal when the blades are in a horizontal plane.

Indeed, the cover provided by these blades ensures protection against rain.

Another patent application, EP 2 817 463, describes a pergola comprising panels that are movable in translation, with superimposed edges. These panels allow the shading to be controlled by moving and superimposing or de-superimposing the panels along horizontal axes X and Y.

This arrangement allows the nature and surface area of the shading, as well as the position of the shaded area, to be easily modified.

The nature of the panels can also be modified, either they are totally rigid panels or they are stretched panels of fabric canvas or even meshed fabric, producing a sunscreen effect, stretched within a frame.

The pergolas according to these patent applications provide total satisfaction.

This invention falls precisely within the same context as a sunscreen, providing variable shading of a surface and offering a multifunction device with the aid of one control unit

This device will now be described in detail with regard to the accompanying drawings, in which the various Figures show:

FIG. 1: a schematic view of a modular multifunction shading device according to the present invention,

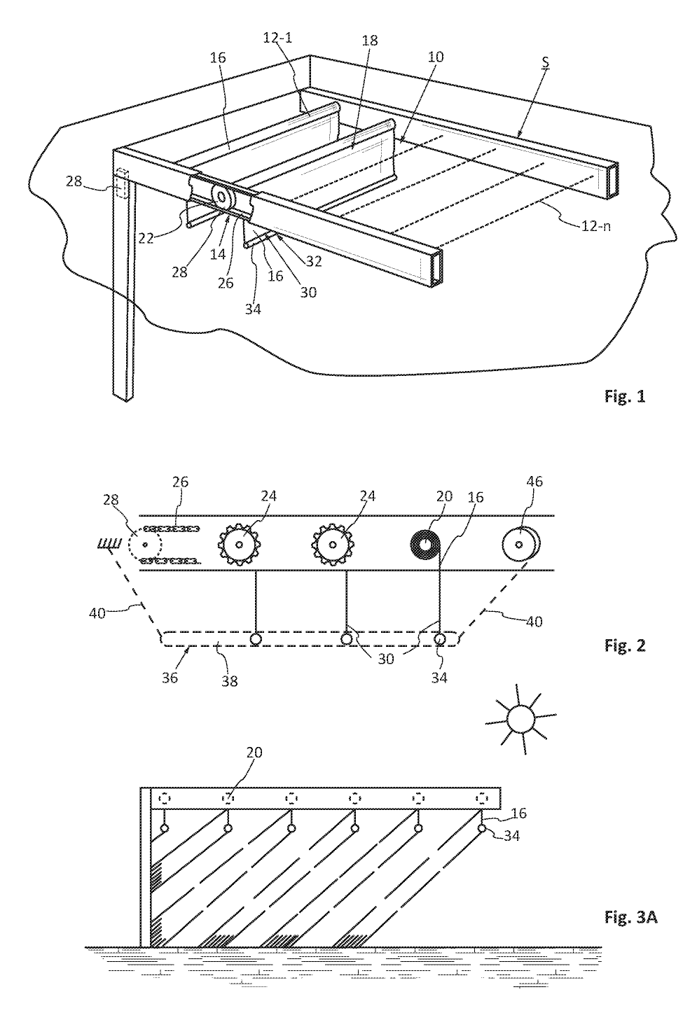

FIG. 2: a schematic side elevation view of FIG. 1,

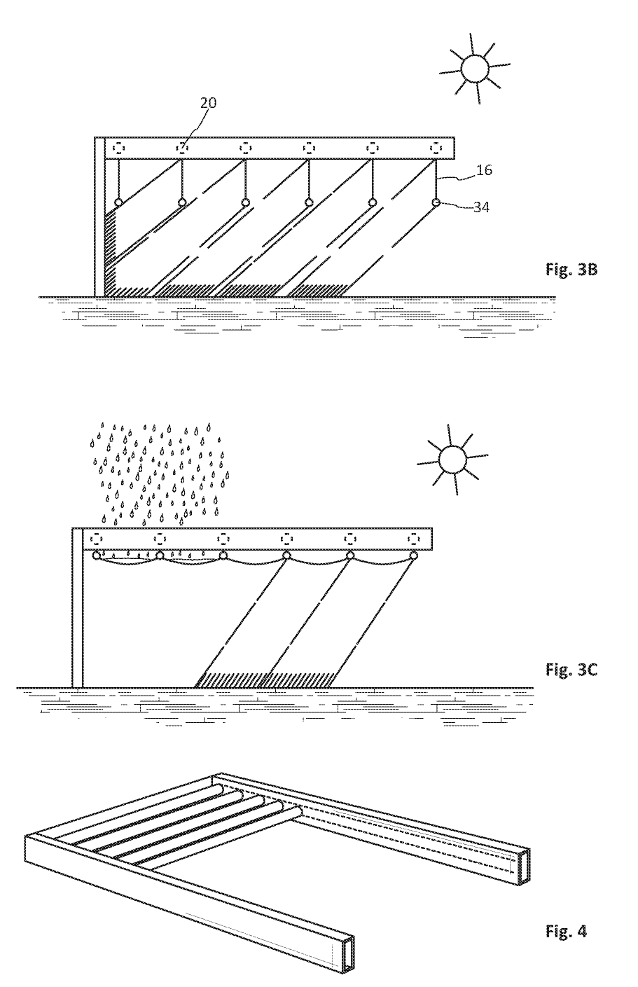

FIG. 3A: a view in the light shading position,

FIG. 3B: a view in the heavy shading position,

FIG. 3C: a view in the sunscreen roof position,

FIG. 4: a view of an enhancement with module retraction means.

The shading device 10 according to the present invention as shown in FIG. 1 comprises a structure S that provides support for said device, said structure comprising in a known way at least two parallel beams and usually a frame and possibly two posts supporting said beams or frame when said beams or frame are isolated and therefore incapable of being connected to walls for example.

The frame is in a horizontal position and the posts are vertical.

This structure comprises at least two longitudinal, horizontal beams, to which the shading device 10 according to the present invention is fixed.

This device 10 comprises modules 12-1, 12-n, distributed along one axis of said structure, in particular the longitudinal, horizontal axis, and means 14 for maneuvering these modules.

In the embodiment shown, each module 12-1, 12-n is equipped with a blind 16-1, 16-n and means 18 to control the length of said blind. In a preferred embodiment, the means 18 to control the length of each blind 16 comprise, for each module, a roller 20 arranged transversely onto which is fixed one end of the blind and means 22 of driving each roller in rotation, in one direction of rotation and in the other direction of rotation, thus causing said screen to be wound up or down.

In a preferred embodiment, the means 22 for driving each roller 20 consist of a pinion 24 integral with said roller and cooperating with a single chain 26 common to the pinions of the various rollers, itself rotated by a motor 28 provided with a driving pinion of said chain.

Thus the motor 28, by turning the chain in one direction or the other, rotates each of the shafts synchronously and causes each blind either to be wound up or down.

The pinion chain assemblies can be replaced by toothed belts and toothed pulleys without in any way modifying the present invention.

The operation of this arrangement leads to the shading being controlled. In fact, when the device is activated so as to totally wind up the blinds, only the shadow relating to the presence of the rollers that intercept the sunrays exists. This situation also arises when the sun is at its zenith.

When the sun is in a position other than its zenith position, the rays are inclined and in fact the blinds can be lowered so as to provide more or less shade against the rays by generating a more or less extensive drop shadow. See FIGS. 3A and 3B.

Preferably, each blind comprises at its base 30, in the bottom part, weighting means 32 so as to keep the blinds substantially vertical.

Advantageously, the weighting means 32 consist of a rigid rod 34.

According to an enhancement of the invention, the device also comprises means 36 to manoeuver the bases 30 of the blinds 12.

These maneuvering means 36 can take the form of at least one bar 38, preferably rigid, connecting the various bases 30, perpendicularly, and in particular at the ends of these bases. This at least one bar 38 can be arranged laterally and, in this case, two bars are provided.

Each bar 38 is itself supported and connected by each of its ends to a traction link 40.

This traction link 40 lifts each bar 38 by its two ends 42-1, 42--n. The traction point is located substantially in the plane of the rollers 20. For this purpose, traction means 44 comprise a motorized drum 46 designed to wind up one end of the traction link 40 that is a closed-loop link, the other end remaining fixed.

When the drum turns in one direction it winds up one end of the link and in the opposite direction, it winds this end down. Thus the reduction in length of the traction link 40 causes the bar 38 to be raised by both ends as well as causing a translational movement.

The traction link 40 allows the bases 30 of the blinds 12 to be raised and to incline them and even place then in a horizontal position. To this end, the traction point of the link 40 to both ends is located substantially in the plane of the rollers 20. In fact, return pulleys can be provided, in a known way.

The length of the blind 12 of a roller can advantageously be adjusted so that, when the rigid bar 38 is brought level with the plane of the rollers, the base 30 is perpendicular to the roller that is juxtaposed to the roller carrying said blind. There is thus continuity of the shading surface that then forms a sunscreen roof. See FIG. 3C.

It will also be understood that the blinds can be made of different materials, either of coated impermeable waterproof fabric or of permeable sunscreen woven canvas or even an alternation of these types of blinds.

The colors can be combined to achieve certain architectural effects.

Such a device has the advantage conferring upon the pergola assembly using this multifunction shading device an advantageous architectural sophistication due to the fact of a certain mobility of the blinds under the effects of the wind, the possibility of adjusting the exposed blind surface and the possibility of adjusting the inclination of said blinds.

Another advantage is the total elimination of the wind factor once the blinds are wound up because then only the structure is involved but then there is no problem with wind resistance.

The device according to the present invention can also be of interest as a variation enabling the rollers to be translated in order to group them next to each other, in juxtaposition. See FIG. 4.

In this case, means to disengage the toothed belt/pulley or pinion/chain assemblies and a hinged connecting bar should be provided so that the latter can fold up between each base. Another variation also involves, depending on the orientation for example, providing winders that are alternated with lowered blinds and other raised blinds and vice versa. This simply involves reversing the winding direction. It is then possible to lower blinds of one color and raise blinds of another color, as desired, depending on luminosity for example. The alternation can be regular or irregular.

Moreover, different lengths with proportional winding speeds can be provided. Thus long blinds are wound up faster than short blinds so that all of the blinds are wound up at the end of travel but have different lengths when they are lowered, particularly when they are in the lowest position.

1-10. (canceled)

11. A multifunction shading device to be supported on a horizontal structure, comprising:
modules supported on the structure, each equipped with a blind, and
means to control a length of each of said blinds distributed along one axis of the structure.

12. The multifunction shading device according to claim 11, wherein the horizontal structure forms a part of a pergola.

13. The multifunction shading device according to claim 11, wherein the means to control the length of each blind comprise a roller onto which is fixed one end of each blind and means of driving each roller in rotation, in one direction of rotation and in the other direction of rotation, thus causing a screen formed by said blinds to be wound up or down.

14. The multifunction shading device according to claim 13, wherein the means for driving each roller comprise a pinion integral with each roller and cooperating with a single chain common to the pinions of the various rollers, this chain being rotated by a motor provided with a driving pinion for said chain.

15. The multifunction shading device according to claim 13, wherein the means for driving each roller comprises a toothed pulley integral with each roller and cooperating with a single toothed belt common to the various pulleys, this toothed belt being rotated by a motor provided with a driving pulley for said belt.

16. The multifunction shading device according to claim 13, wherein each blind comprises at its base, in the bottom part, a weight and means to maneuver the bases of these blinds.

17. The multifunction shading device according to claim 16, wherein the maneuvering means comprise at least one bar connecting the various bases, perpendicularly to said bases, each bar being supported and connected at each end thereof to a traction link, and traction means that raise and move said bar in translation.

18. The multifunction shading device according to claim 17, wherein the traction means comprise a motorized drum.

19. The multifunction shading device according to claim 11, wherein the blinds are made of at least one of coated impermeable waterproof fabric or permeable sunscreen woven canvas.

20. The multifunction shading device according to claim 19, wherein the blinds are made of an alternation of blinds that are made of coated impermeable waterproof fabric and permeable sunscreen woven canvas.

21. The multifunction shading device according to claim 13, wherein the winding directions are alternated for alternating blinds.

22. The multifunction shading device according to claim 13, wherein winding speeds and lengths of the blinds are different.

23. A multifunction shading device to be supported on a horizontal structure, comprising:
a plurality of modules, each equipped with a blind and secured to said horizontal structure, and
a control apparatus configured to control a length of each blind arranged along a horizontal axis of said structure.

24. A multifunction shading device, comprising:
a horizontal support structure,
a plurality of modules, each equipped with a blind and secured to the horizontal structure, and
a control apparatus configured to control a length of each blind arranged along a horizontal axis of the structure, comprising a roller onto which is fixed one end of each blind and a mechanism configured to drive each roller in rotation, in a first direction of rotation and in a second direction of rotation, thus causing a screen formed by said blinds to be alternately wound up or down.

25. The multifunction shading device according to claim 24, wherein the mechanism configured to drive each roller comprise a pinion integral with each roller and cooperating with a single chain common to the pinions of the various rollers, this chain being rotated by a motor provided with a driving pinion for said chain.

26. The multifunction shading device according to claim 24, wherein the mechanism configured to drive each roller comprises a toothed pulley integral with each roller and cooperating with a single toothed belt common to the various pulleys, this toothed belt being rotated by a motor provided with a driving pulley for said belt.

27. The multifunction shading device according to claim 24, wherein each blind comprises at its base, in the bottom part, a weight and a maneuvering device comprising at least one bar connecting the various bases, perpendicularly to said bases, each bar being supported and connected at each end thereof to a traction link, and a motorized drum to raise and move said bar in translation.

28. The multifunction shading device according to claim 24, wherein the blinds are made of at least one of:
coated impermeable waterproof fabric,
permeable sunscreen woven canvas,
alternately, of coated impermeable waterproof fabric and permeable sunscreen woven canvas.

29. The multifunction shading device according to claim 24, wherein the winding directions are alternated for alternating blinds.

30. The multifunction shading device according to claim 24, wherein winding speeds of the blinds and lengths of the blinds are different for different blinds in the plurality of modules.
